(19) United States
(12) Patent Application Publication
(10) Pub. No.: US 2007/0012518 A1
(43) Pub. Date: Jan. 18, 2007

(54) Gravity generator of electricity or how to use gravity to generate electricity by means of pendulums

(76) Inventor: Maximo Gomez-Nacer, West New York, NJ (US)

Correspondence Address: MAXIMO GOMEZ NACER & ISMARY GOMEZ, 232, 67TH STREET, APT: 1, WEST NEW YORK, NJ, 07093-3294, US

(21) Appl. No.: 11/178,869

(22) Filed: Jul. 11, 2005

(51) Int. Cl. F03G 3/00

(52) U.S. Cl. 185/27

(57) ABSTRACT

The system and the method of obtaining electricity by means of the use of the force of gravity by incorporating pendulums which weight and velocity provide energy for electricity generation while a weight storage from any additional source or structure provide the additional force to overcome resistance by using hydraulic high-pressure chambers or gears in order to power turbine to power pendulums to power an electricity generation or by the use of the any weight to power gears to power pendulums to generate electricity.

Gravity is the best free source of energy.

Gravity is the force that moves the Universe.

The concept I want to introduce today in this patent is completely new. We all know that gravity it is such a powerful force that it governs the movement of celestial bodies but today I want to introduce the concept of using gravity to our advantage to generate electricity. By means of the following pages I will explain how.

Our grandfathers discovered that “weight” is a form of energy that could be “stored” for a long period of time and they built clocks with gearings that needed winding only once a year by using weights. Ever since Galileo described the principle of the pendulum to Vincenzo Viviani in 1641 and since the horologium of Huygen's described this more accurate clock in 1656; pendulums have been used for its unique property of keeping a constant period regardless of the weight and the amplitude of the swing. This property of the constant period allowed its use for centuries in the music industry and more importantly in the manufacture of the first accurate clocks. But our ancestors overlooked the most important part of their discovery, which is related to the force of gravity. Energy is directly proportional to Mass and velocity therefore if we use a heavy anchor in the pendulum (mass) moving back and forth (velocity) powered by the gravitational force, then we can power a generator of electricity. Very simple!

Pendulums are a very efficient way of using the force of gravity, providing movement for a long time with small investment of energy. We only need a proportionally small investment of energy to make the swing return to the same position all the time by overcoming the lost in resistance by friction. The additional source of energy is also weight, any weight thanks to the force of gravity. On one axis we have the force of the weight of the anchor of the pendulum on the other axis we have one additional weight that is enough to overcome all the resistance of the mechanism as well as the resistance of the electricity generator. The more weight that we use and the longer the amplitude of the swing (and therefore velocity) then the more energy. No wonder pendulum hammers work so well; because they carry a lot of energy.

Once we have one heavy object (or one thousand objects) moving back and forth then we have the equivalent to pistons moving horizontally and we transfer that force to the drive shaft to a generator by means of a level (or also any added arm) which allow us to obtain the most of that energy into the rotational movement by means of an additional pivot axis and a dentate wheels or similar binding mechanism. The principle can be used to transfer that force of the weight to a generator by means of using a lever that provides multiplied movement to the generators main axis. This is a powerful energy and it is “free” for as long as we have a compensatory weight without reaching the ground that keeps the pendulum moving. In order to move a pendulum continuously for a long period of time (example more than twenty-four hours we need a compensatory weight of about one hundred and fifty to two hundred and fifty times the weight of the anchor, depending on several factors (like the desired distance to the ground) but by simply adding weight we can overcome literally any resistance of any generator. The potential for use of this energy is endless. In order to achieve an optimum rotation of the inducers wheel it is envisioned that we use more than one pendulum. The final generation of electricity is going to be directly proportional to the number of pendulums used, their weight, and their length of the swing that will allow us to move bigger generators. This is simple a good concept superior to nuclear energy because it is safe and it requires minimal investment.

One of the only additional inconveniences of the use of this energy is that we have to “rewind periodically the weight”. In this patent it will be explained the different alternatives envisioned in order to ease this work. (Like by using another device patent envisioned by the same author before). The fact is that “rewinding” the weight only takes a small fraction of the energy generated by using pendulums.

If we want to move one pendulum that weights one hundred pounds back and forth continuously for twenty-four hours we use an escapement mechanism and we need a compensatory weight of approximately 150 to 250 times the anchor and arm weight. In this patent I want to describe a new kind of “escapement mechanism” that allows us to move not one but SEVERAL pendulums using the same weight. I have named it the “time consecutive escapement” and it consists on an escapement like the used by the old clock masters but eliminating the “stop” component. In other words by using only one teeth (instead of two) we can use the weight more efficiently because we eliminate the resistance of the second teeth and now we can power consecutively several pendulums at different consecutive times (see FIG. 10). This is equivalent to having several clocks moved with the same battery without additional cost in energy or battery consumption. It is envisioned multiple additions in this area in order to make the work even more effective by decreasing even further the resistance. But this will be the topic of another patent.

Functioning prototypes: I have envisioned four prototypes.
Simple hydraulics prototype (FIGS. 1 to 8)
Architectural hydraulics prototype (FIGS. 4A; 4B; 4C; 4D, 5; 6, 7A; 7B; 7C; 8A; 8B)
Architectural mechanical prototype (FIGS. 8A; 8B; 9; 10A; 10B)

Simple mechanical prototype (FIGS. 11A; 11B; 12; 13)

Simple hydraulics prototype (less than fifty tons of weight energy or pressure) is the prototype that uses the advantage of hydraulics like in any hydraulic system by means of two chambers of pressure (high and low pressure where liquid (ex hydraulic fluid or oil) compressed under the weight of the structure is converted into rotational energy. The weight (less than fifty thousand pounds (which is our stored energy) provides pressure to the fluid that move the turbine to power our pendulums. The advantage of this model is that there is minimal lost in friction because we are not using gears and the liquid goes directly to power a point of less resistance which is a low velocity turbine. The weight can be “recycled up” investing relatively few of the energy generated. Gravity does most of the job moving the pendulums while the weight of the frame, the generator; the pendulums etc provide its own initial “weight” energy exerting pressure over hydraulic chambers.

Architectural hydraulics prototype (more than fifty tons of pressure) This hydraulic model goes one step further because it uses very heavy architectural structures a source of weight energy. The idea is designing buildings that power their own electricity by using the pressure that the structure exerts on the floor as a source of power. Using hydraulic jack can transfer that pressure backwards to a low velocity turbine that powers the pendulums. Again, the concept is simply adding hydraulic jacks to the load of every column that allows us to produce a backward pressure on the low velocity turbine that powers our pendulums.

It is envisioned the use of this concept in literally any architectural project. Building structures, bridges, and even to big tanks containing liquid (such as oil) for example to exert a tremendous load on the ground. What is a problem for the architects design (example how to distribute millions of pounds of pressure on the ground; now becomes the most desirable feature because those pounds represent energy that can be recycled. One of the few disadvantages of this prototype is bigger cost and liking seals after long time of exposure to the chambers of pressure.

Architectural Mechanical Prototype

Consists on a frame of steel supported on the foundation of a building structure in order to provide support to a train of gears in order to transfer the energy from the weight load of a building structure into pendulums (FIGS. 9, 10) (Since we have gears, we do not need the low velocity turbine to power the pendulum) The “weight energy” is transferred directly to a mechanism similar to the mechanism of a clock but since we want to make an optimum use of the energy we will use several pendulums as explained before by using the “time consecutive escapement”. In this case the weight energy is going to be transferred from the gears to the “time consecutive escapement” mechanism that powers the pendulums. This mechanism—as explained already—has the same function of the escapement mechanism of a clock but it has the advantage of using the weight energy much efficiently on the right timing and it is going to be used in all the prototypes. The lower part of the frame of this mechanical prototype is directly supported on the foundation of the building structure while the load column of the building structure is supported by a moving mechanism (like a big clock that powers big pendulums). By “gearing” the load of a column we obtain the desired rotation at the drive wheel of the pendulums. Then we can keep gearing it down to an end where by exerting a relatively smaller force we can “recycle the weight up. The building structure moves up and down symmetrically again providing the power to the gears that power the time consecutive escapement mechanism that powers the pendulum that powers the generator. The main application of this prototype is construction of homes and multifamily buildings that will power their own heating and cooling or energy bill. It can be used in any building that adds the small cost of additional steel structure to the foundation. The advantage is “having an autonomous energy bill” proportional to the total weight of the structure being used.

Simple mechanical prototype: Consist on a relatively inexpensive frame (with a significant saving in steel compared to all the other prototypes) the frame will still be strong enough to support a weight 150 to 250 times the weight of the anchor. (FIG. 11) The pounds or “weight energy” can be “stored” in any way; either putting them approximately six meters above the ground (as in this drawing) or creating a vertical tunnel to store and recycle them underground (FIG. 12) or even taking the advantage of the topography in such a way that does not contaminate the view. (FIG. 13) By using proportional gears we transfer that weight into the time consecutive escapement mechanism that provides the powers to the pendulums and the generators. Once a day approximately we have to “rewind” the power, which is done with the help of a mechanical lifter (like the ones used to lift engines in any garage). The total weight (example 15 000 pounds) is fragmented in smaller weights (example 30 pieces of 500 pounds each). It is envisioned the use of horses (or other animals) using the animal powered electricity generator or the horse speeding vehicle in order to facilitate the labor of “recycling the weight. The main advantage of this model is simplicity and low cost. It can be assembled practically anywhere. The source of energy (weight) can be anything (Example, sand, water, Sault) suspended from the winch that powers our pendulums. The vital components like the winch, the gears and the generators require steel and cupper that only few countries can process and bring to a final product.

The main application of this prototype is Universal. It is relatively inexpensive and easy to install and operate and it can be assembled literally anywhere we need electricity. It can be used in order to provide the ideal source of energy to develop new wave of farms by bring autonomy from the energy bill. By extending this alternative it is envisioned the decrease in the energy cost to allow the use of water out of the sea and desalinizing it for further use at inland agriculture. It can also bring independence of energy bill to many areas in remote areas, from mountains to small islets. In this patent the simple mechanical prototype can be seen in pictures eleven twelve and thirteen. The way in which the pendulums move the generator is the same regardless of whether we use hydraulics of mechanics prototype and the figures one two and three of this patent can assist in a better understanding.

### BRIEF DESCRIPTION OF THE SEVERAL VIEWS OF THE DRAWINGS

Figures of this patent to describe the Gravity Generator (GG)

FIG. 1 one depicts a lateral view of the electricity gravity generator powered by hammer pendulum. (Hydraulics prototype)

FIG. 2 depicts the frontal view of the electricity generator powered by hammer pendulum (Hydraulics prototype)

FIG. 3 depicts a three dimensional view of the electricity generator powered by hammer pendulum (Hydraulic prototype)

FIG. 4 depicts the stages of the building of the foundation of the electricity generator powered by hammer pendulum ((Architectural hydraulic prototype).

FIG. 4a) Stage one

FIG. 4b) Stage two

FIG. 4c) Stage three

FIG. 4d) Stage four

FIG. 5 represents a “flip flop” building constructed above Stage four of the prior figure. (Architectural hydraulic prototype)

FIG. 6 depicts the attachment point for the load of a building structure to the foundation in order to transfer that energy into circular motion (architectural hydraulic prototype)

FIG. 7 seven depicts the hydraulic turbine. (Used in both, the simple and the Architectural hydraulics prototype)

FIG. 7A depicts the lateral view of the wheel of the turbine (internal mechanism)

FIG. 7B depicts a lateral view of the turbine

FIG. 7C depicts a detail from 7B in order to demonstrate the “enclosed spoon design” of the distal end of the blade of the generator.

FIG. 8 depicts the pendulum specially designed to power a generator. (Used in both Hydraulics and mechanical prototype)

FIG. 8B depicts a lateral view of the movement of the pendulums the levers and how it powers the generator.

FIG. 9 depicts a detail of the lateral view of the attachment point for the load of a building structure to the foundation in order to transfer that energy into circular motion (architectural mechanical prototype)

FIG. 10 depicts a 3-D view of the architectural mechanical prototype zoomed out from the prior figure. It depicts a horizontal train of gears.

FIG. 10B. Depicts a variation of the architectural mechanical prototype by using a vertical train of gears and by using a horizontal arm instead of a lever to power a dentate wheel

FIG. 11 depicts a lateral view of the generator (simple mechanical prototype) using simple weights above the ground.

FIG. 11B depicts a simple mechanical prototype (superior view)

FIG. 12 depicts the use of the generator using a vertical tunnel (simple mechanical prototype)

FIG. 13 depicts the use of the generator taking advantage of the topography. (Simple mechanical prototype)

### BRIEF DESCRIPTION OF THE SEVERAL VIEW OF THE DRAWINGS

### Description of the Figures

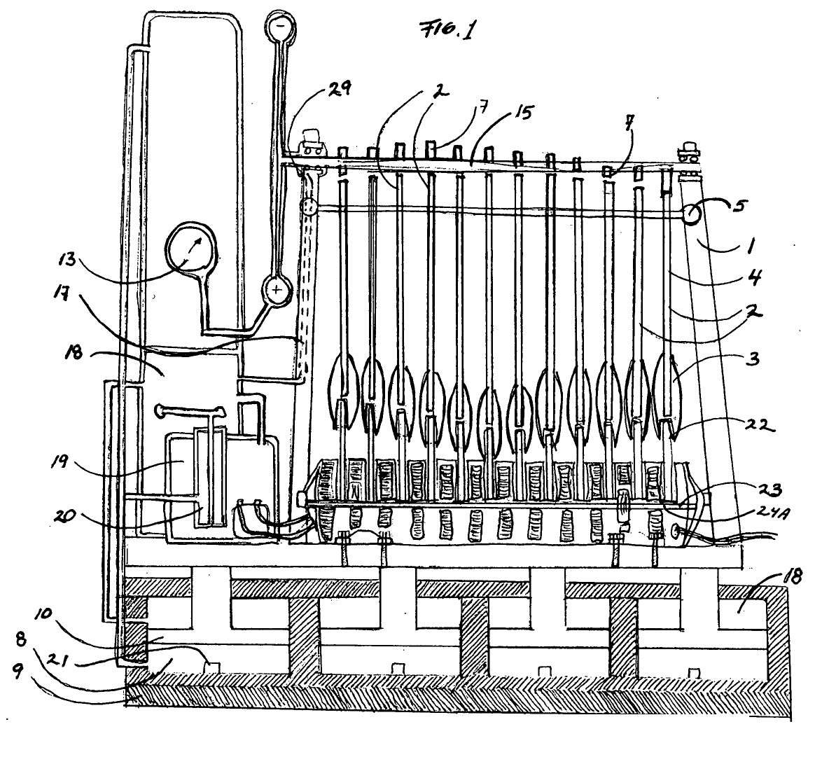

1-FIG. 1 depicts a lateral view of the electricity generator powered by hammer pendulum (powered by hydraulics compression from the weight of the structure).

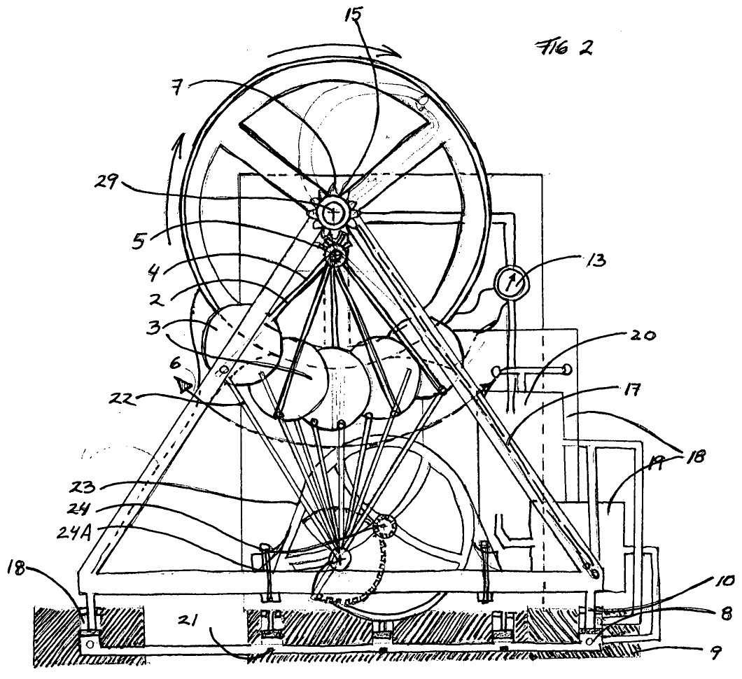

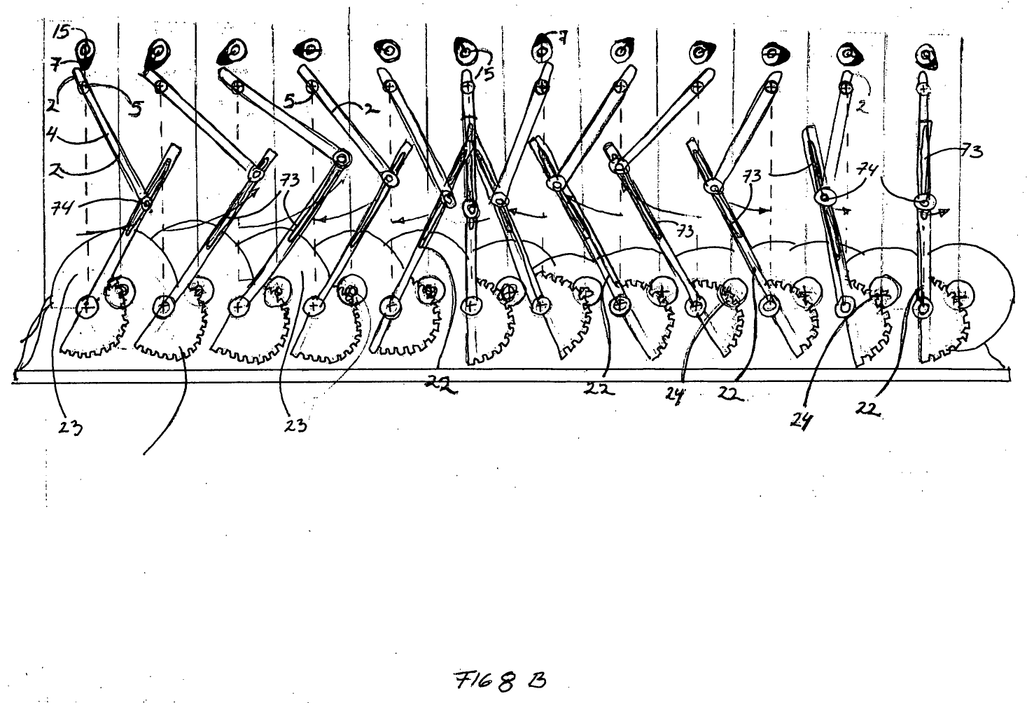

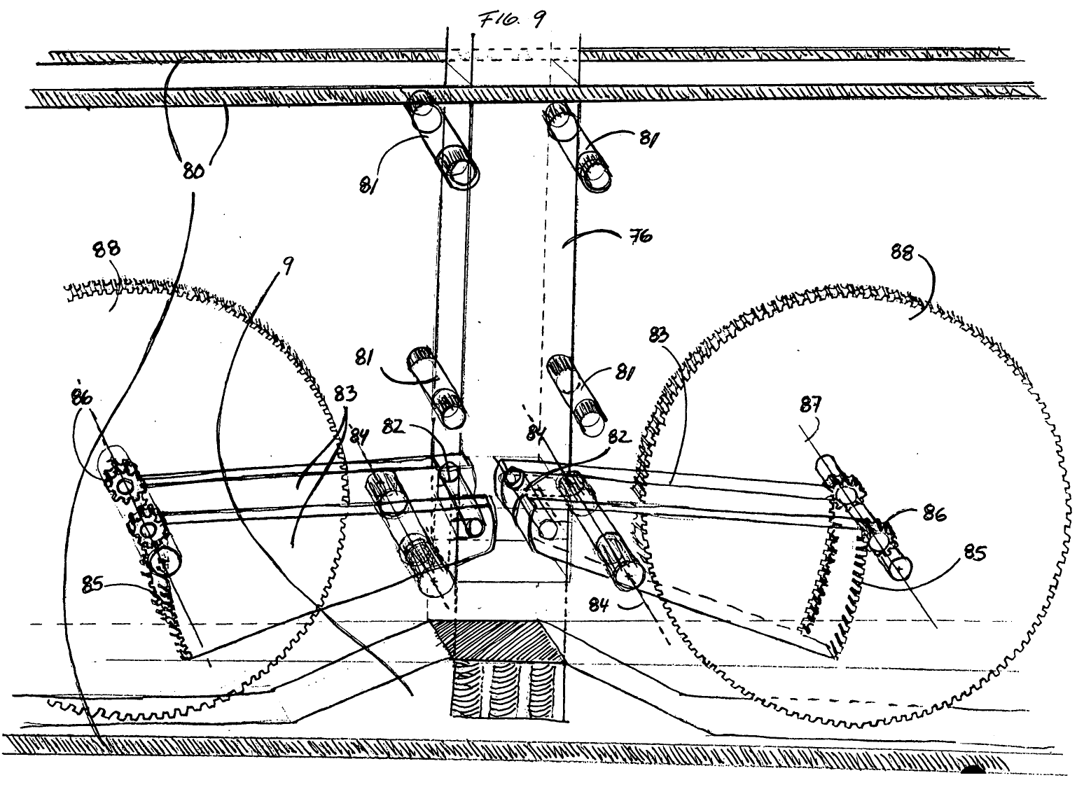

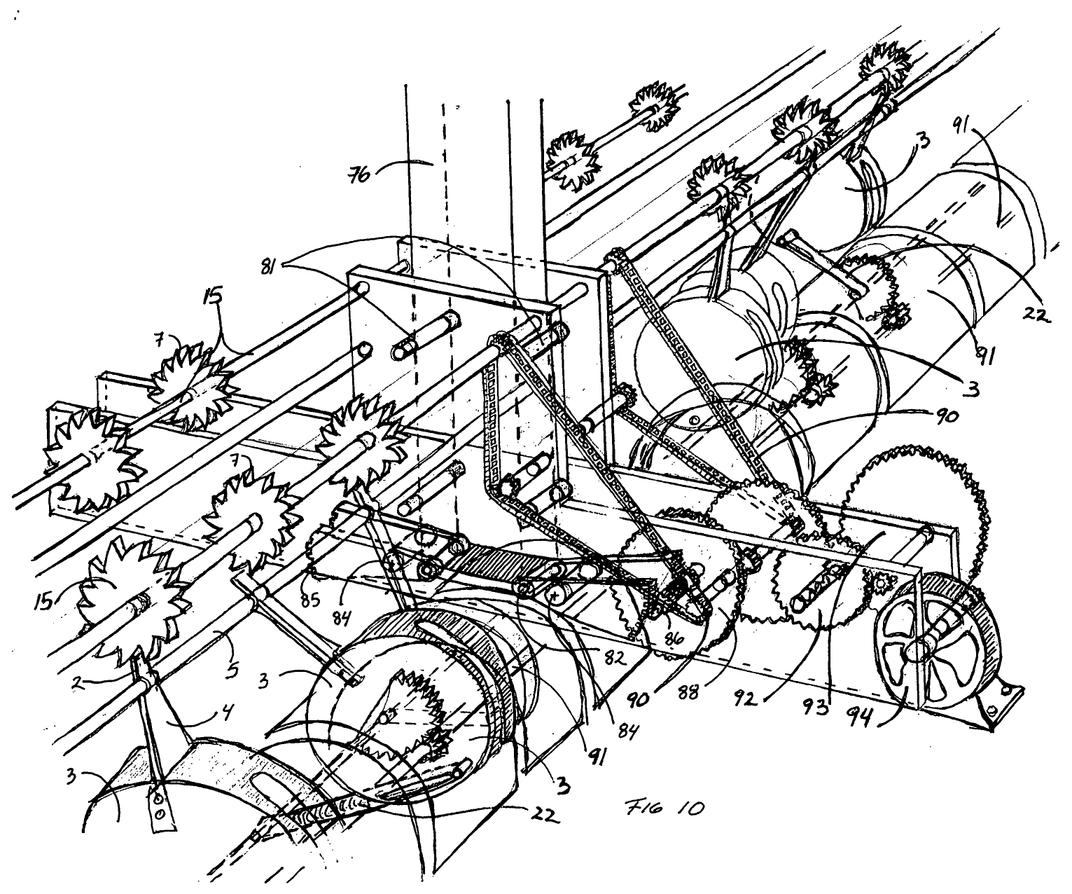

The pictures depicts a frame 1 that supports twelve pendulums 2, which has an anchor 3, supported by the arm of the anchor 4. The arm is attached to a pivot axis 5. The pendulum moves back and forth supported by the pivot axis 5 at a regular period describing an arch in its trajectory (see also FIG. 2) while a powering pin 7 provides the pushing energy into the pendulum to overcome the loss of energy caused by friction and to allow it to keep swinging. The powering pin of the “time consecutive escapement” is powered by hydraulics coming from the high-pressure chamber 8 created at the foundation 9 of the structure by means of specially designed piston 10 that compresses the liquid at the pressure chamber 8. There is a hose 11 that connect that high-pressure chamber to the container or high-pressure tank 12 and from there a regulator 13 to keeps constant the pressure coming out of the tank. The high-pressure hydraulic fluid powers the hydraulic turbine 14 (see FIGS. 7A;7B;7C); which in turn powers the sinusoidal pin mechanism or time consecutive escapement 15 where the powering pins 7 are attached in a continuous manner. The time consecutive escapement mechanism is supported by al least two ball bearings 16. The excess hydraulic fluid from the high-pressure chamber is directed by means of internal connections in the mechanism 17 to a low-pressure container 18. The powering pins 7 that are part of the “time consecutive escapement 15 transfer its energy continuously to a sequence of pendulums 2 one after the other. The regulator device 13 regulates the hydraulic fluid in order to obtain the maximum rotation with the lesser pressure. The pressure is also regulated with the help of a pump 19 by means of an additional valve 20. When the pistons 10 are getting closer to the bottom of the high pressure chambers 8, there is a sensor 21 that activates the pump 19 to start pumping pressure back from the low pressure chambers into the high pressure one. This process will consume a small part of the energy since the use of unidirectional valve will allow mechanical advantage in building up the pressure. The pressure will also accumulate in the pressure tanks in the form of storage energy that will allow powering the turbine for a longer period of time without need of frequent “pumping up of the building structure” so that we can re-use that weight. The energy generated is many times the amount of energy used in pumping up the structure because the use of the pendulums allows a continuous significant mechanical advantage since that movement is created mostly by the effect of the force of gravity (free) on the weight of the anchor and we consume only a fraction of that power lost in the resistance of the mechanism. On the other hand we can attach multiple pendulums to the same time consecutive escapement mechanism, which will increase the efficiency. The picture depicts twelve pendulums as described before. The back and forth movement of the pendulums power the electricity generator by means of a levels 22. The levels run along a grove inside the pendulum anchor 3. The levels are attached to a pivot axis 24 that is parallel to the main pivot axis of the electricity generator 23. There is a semicircular dentate wheel that powers the drive shaft of the electricity generator. The bigger the weight we use in the anchor the bigger the generator that we can use.

2-FIG. 2 depicts a frontal view of the electricity generator powered by hammer pendulum where the proximal side is the side of the hydraulic turbine. The hydraulic turbine has a long wheel 14 in order to allow maximum effect and maximum mechanical advantage on the powering pins 15 of the time consecutive escapement. The pressure of the hydraulic fluid moving at a low velocity powers the turbine, as it will be described furthermore.

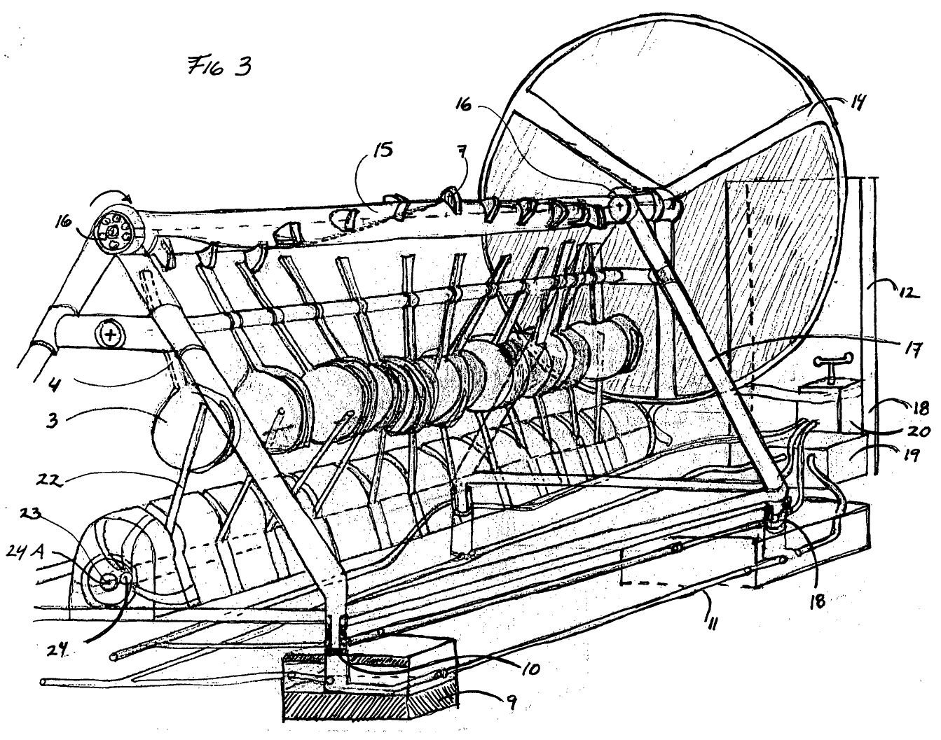

3-FIG. 3 depicts an elevation view (3-D) view of the apparatus where the turbine is at the bottom of the figure. The numbers correspond to the same description given before and the pendulums appear in movement in a consecutive manner powered by the time consecutive escapement.

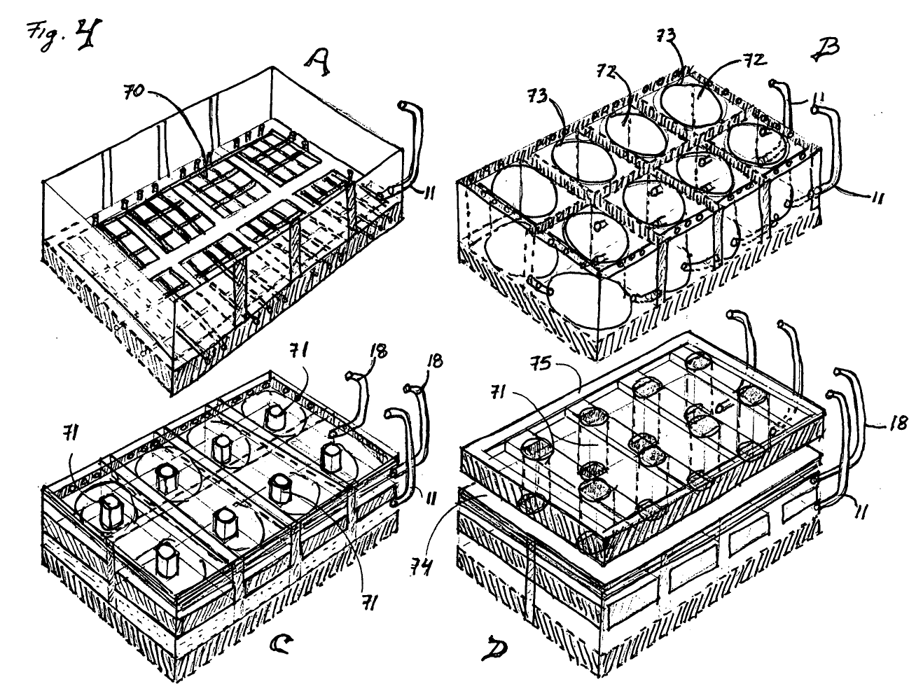

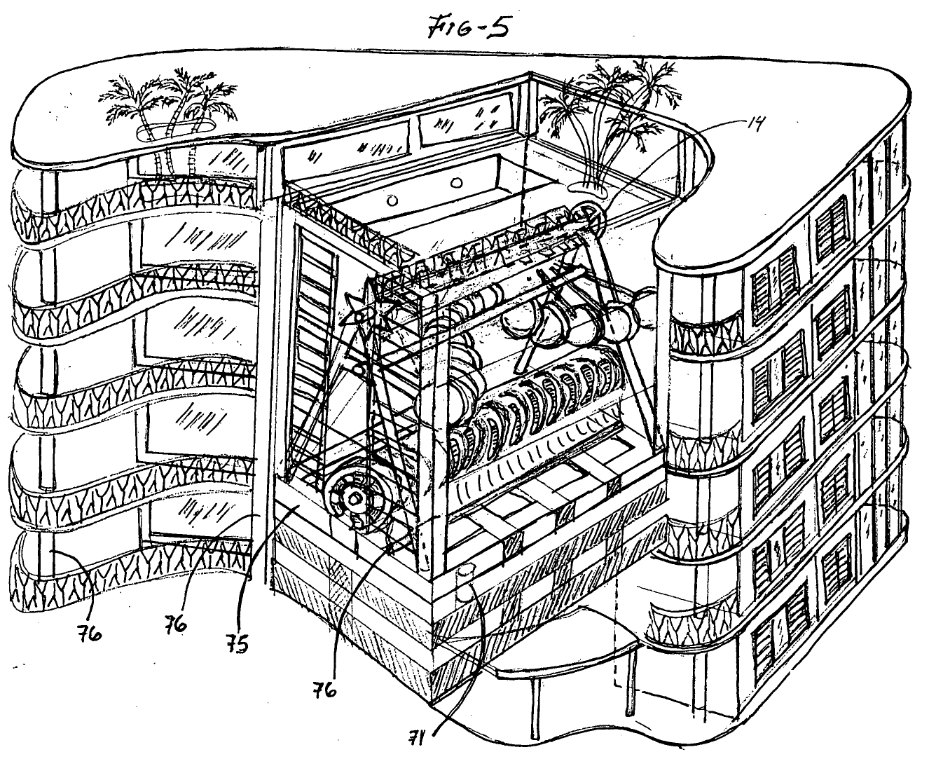

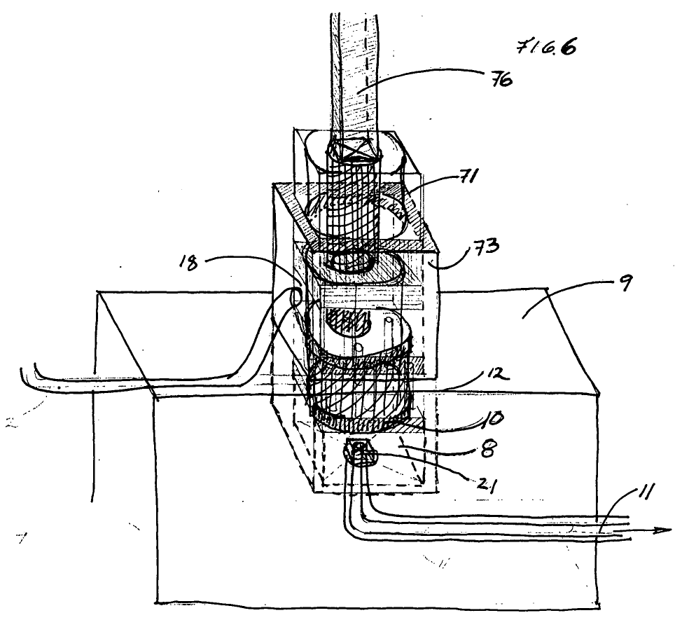

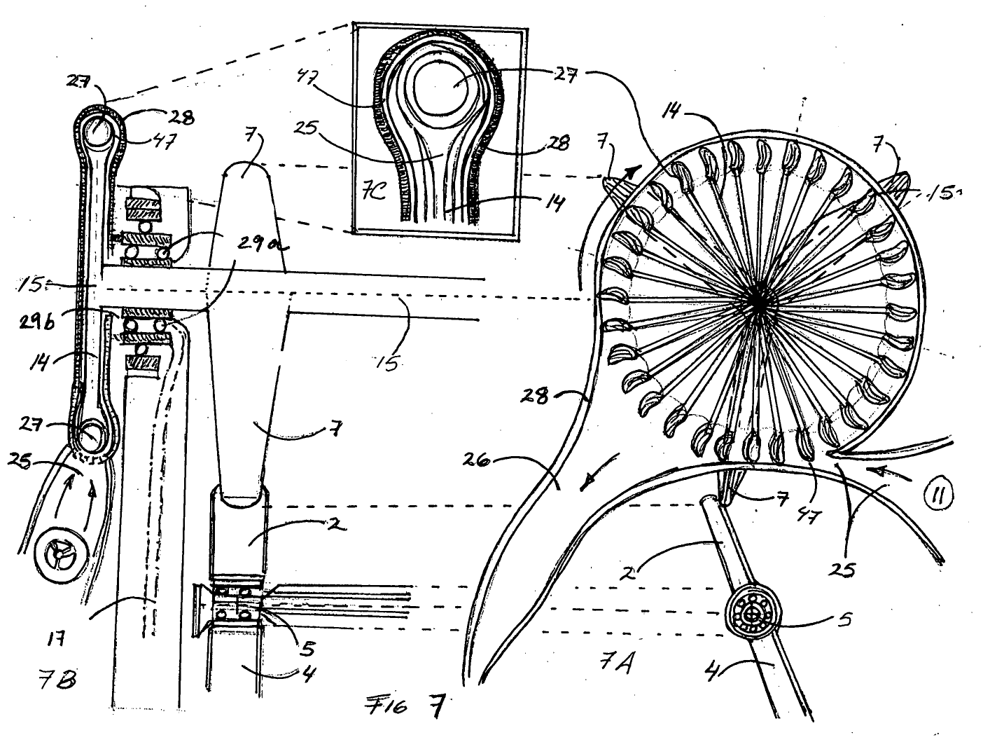

4 FIG. 4 depicts the stages of the building of the foundation of the electricity generator powered by hammer pendulum ((Architectural hydraulic prototype).

4a) Stage one consists on making the excavation on the terrain, creating a foundation frame and placing the steel grid 70. There is one or more high-pressure connection 11 to bring that pressure to the turbine.

4b) Stage two consists on creation of compartments or “pools” 72 connected in the lower portion of all the pools or high pressure compartments 11 that are connected to the high pressure connection 11. The pools have also connections in their upper portion. The upper portions of the pools 72 are going to become the low-pressure compartment 18. These pools are going to serve as foundation of the metal cylinders 73 that contain the hydraulic fluid.

4c) Stage three: Consists on placing the compression cylinders 71 inside the containing cylinders 73

4d) Stage four consists on the installation of a seal or tube around the compression cylinder 71 and a roof 74 to the pools 72 that is going to finally create the two chambers of pressure; the high pressure chamber 11 (below the cylinders and the low pressure chamber 18 (above the cylinders). Note that above the roof 74 there is a platform 75 that connects all the compression cylinders.

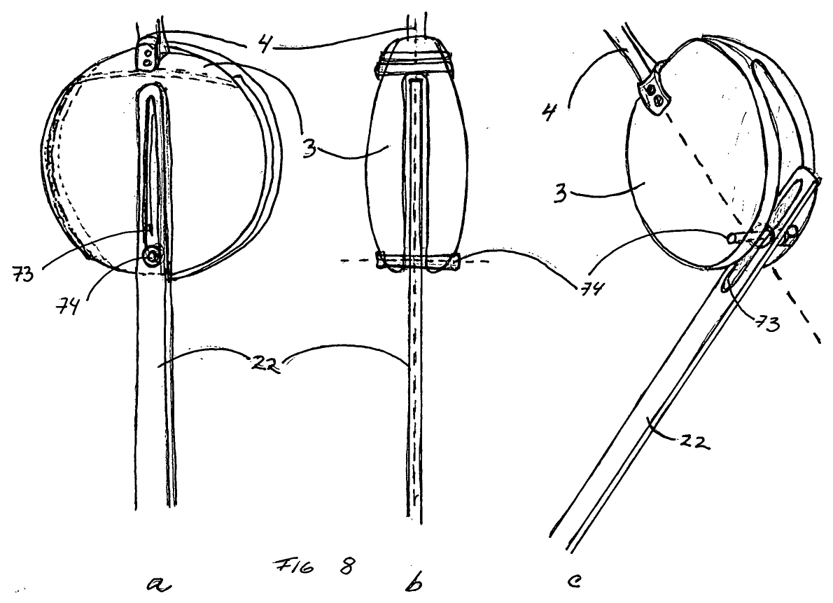

5. FIG. 5 represents a building constructed above Stage four of the prior figure. The load columns 76 of the building might be a continuation of the “pistons” or compression cylinders 71. The building might also be erected over a platform 75 that connects all the pistons at the same level. (Architectural hydraulic prototype). The concept of “flip-flop” building comes from alternating sections of the building going up and going down in order to allow continuous power pressure over the turbine. In other words, when one section is “coming down” creating pressure, the other section is being “pumped up” so we can always have “stored weight energy”. By moving up and down the building structure only a few inches (example four inches) we can have a large volume of liquid to power our low velocity turbine 14.

6. FIG. 6 depicts the attachment point for the load of a building structure to the foundation in order to transfer that energy into circular motion (architectural hydraulic prototype). The load column 75 exerts pressure over the piston 71 that compress the fluid at the high-pressure chamber 11. The leaking hydraulic fluid can go into the low-pressure chamber 12 from where it is taken to a container (not seen in this picture) by means of a tube 12. The foundation of the structure 9 provides support to the cylinders 73 that contain the piston 71. There is a sensor 21 that sends a signal to the pump 19 (not seen in this picture) when the piston reaches the lowest desired point.

7-FIGS. 7 (7A, 7B, 7C) depicts the hydraulic turbine.

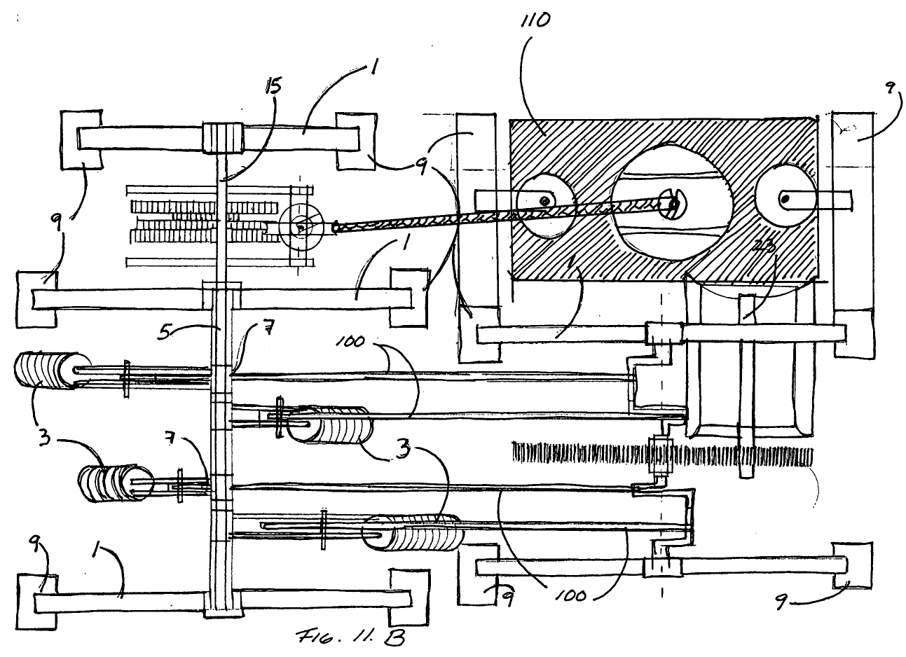

7 A depicts a lateral view of the low velocity turbine. The pressure of the compressed fluid under the weights powers this turbine, which is enclosed, covered by a surface 28 that creates a seal to the fluid. There is a pivotal axis 28a that supports the blades of the turbine 14. The blade's rotation makes rotate the main axis 15 that powers the pendulum(s) 4. At the distal end of every blade or arm 14 we have a “circular spoon like” surface 27 that matches almost exactly the diameter of the “neck” of the incoming pressure tube 25. The turbine is going to be receiving the pressure from the high-pressure chamber 11 at this particular surface area 27. The high-pressure chamber has a narrowing or “neck” 25 just before reaching the turbine's surface 27. In other words that the diameter of the tube bringing the hydraulic pressure from the compression chamber is several times bigger than the “neck” this is done so that there is minimal resistance around the tube by the time the fluid reaches the “circular spoon like surface”. The “spoon” shape 27 provides increase the surface area where the high-pressure fluid exerts pressure that moves the pivot axis 15. The pivot axis in term moves the pin 7 or timed consecutive escapement that powers the pendulums 4. The amount of pins 7 will depend of the length of the arm of the pendulum and therefore the time that it takes to the anchor to return to the same position. (This is why the amount of pins in this picture is only 3 pins while in FIG. 10A the “pins” 7 or teeth of the time consecutive escapement” have 14 pins or teethe closer one to the other) The movement of the pivot axis 15 is supported by ball bearings 29a. The Axel 5 of the pendulums 4 has also ball bearings in order to facilitate its movement. The turbine moves the pin that moves the extension 2 of the arm of the pendulum providing the additional energy necessary to overcome the loss in resistance of every cycle. After the hydraulic moves the arms of the turbine, there is a lower pressure chamber 26 that collects the fluid back into a low pressure tank (not seen in this picture) where the liquid is stored until it is needed to pump up the pressure again. There is also a small hole around the pivot axis of the turbine 29b that allows the passage of a small portion of fluid that might leak around the ball bearings into the low-pressure container by means of a collector tube 17

7 B depicts a lateral view of the turbine. Please note the powering pin 7 or time consecutive escapement. The arms of the turbine form a letter “I” with the pivot axis that contains the pin or time consecutive escapement and it is build with the precision of any other engine so that it engages the pendulum exactly at the time it reaches the desired position.

7 C depicts a detail of the lateral view of the turbine to demonstrate the spoon shape 7 surface area 27 of the distal blade 14 enclosed on a covered surface 28. Note that there is a small free space 47 between the surface area 27 and the cover surface 28 that encloses the turbine.

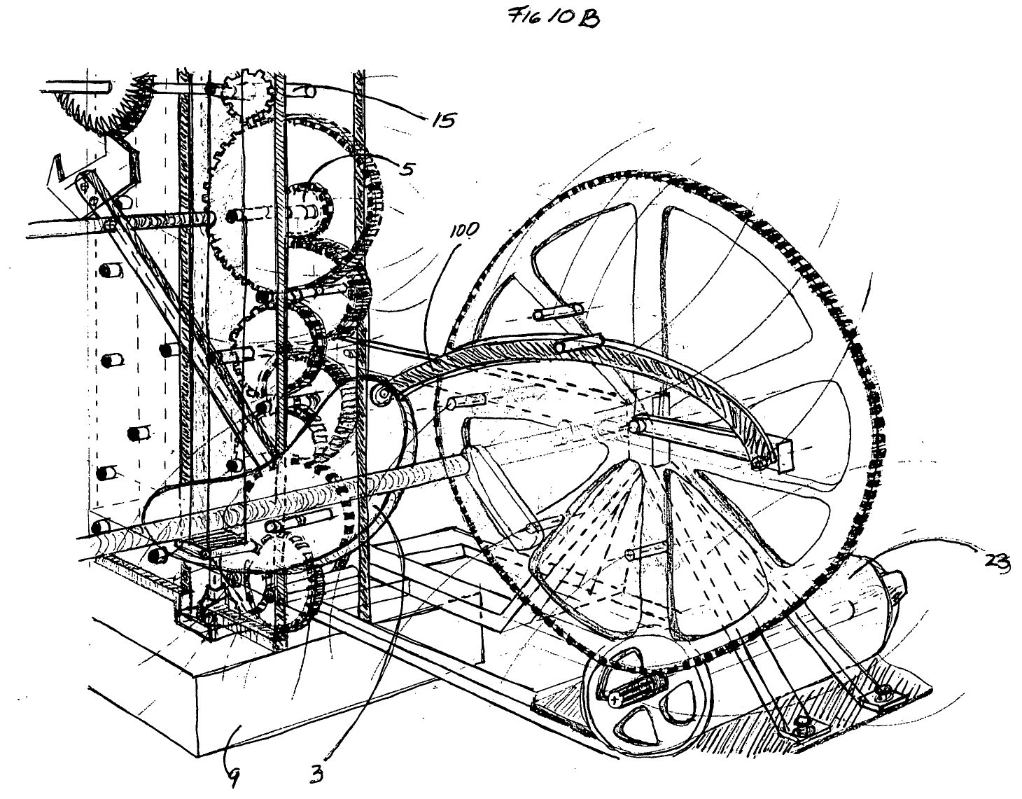

8-FIGS. 8 A, B, C depicts the specially designed pendulum.

8a is a lateral view

8b is a frontal view

8c depicts an obliquely view: This picture depicts the attachment point of the pendulum to the lever 74The arm of the pendulum supports the anchor and in turn the anchor has a pin 74 to bind the level in such a way that every back and forth movement of the pendulum produces an equivalent movement of the level. The picture is self-descriptive. The lever has a grove 73 that allows the pin 74 of the pendulum to slice inside it with the movement. The lever functions as a crank that produces rotational force on the generator by means of a semicircular dentate wheel engaging the drive shaft of the generator. (FIG. 8B)

FIG. 8B depicts a lateral view of the movement of the pendulums the levers and how it powers the generator. The pin 74 moves inside the grove 73 and produces rotation along a pivot 24A where there is a dentate wheel that in turn powers the drive shaft of the generator 24

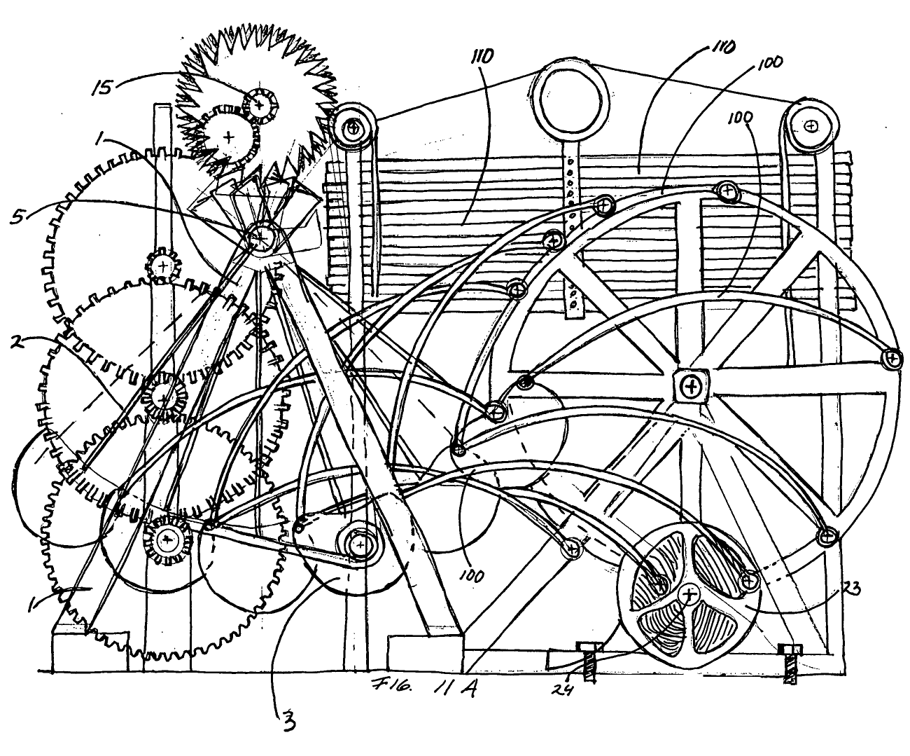

9. FIG. 9 depicts a detail of the lateral view of the attachment point for the load column 76 of a building structure to the foundation 9 in order to transfer that energy into circular motion (architectural mechanical prototype). The load column is literally separated from the definitive foundation 9. The column is hold in place surrounded by two parallel sheets of metal 80 that are supported by the foundation 9. There are several cylinders 81 that surround the load column in order to hold it on place while allowing only vertical movement (example up and down). There is a point to bolt 82 the load column in the lower portion to four levers (wedge shaped) with a pivot axis 84 proximal to the load column 76. The four levers have a dentate surface in the opposite end, which in turn rotates another gear 86 supported on the two sheets of metal. This said small gear 86 is in turn in the same axel 87 of a bigger wheel 88 than in terms continues to provide rotational energy to a gear of train supported by the same sheets of metal or equivalent support that is definitively supported by the foundation of the building. The other gears are not represented in this figure for the sake of simplicity. 10. FIG. 10 depicts a 3-D view of the architectural mechanical prototype zoomed out from the prior figure. It depicts a horizontal train of gears receiving the weight energy from the structure from the load column 76. The load column is literally separated from the definitive foundation 9. The column is hold in place surrounded by two parallel sheets of metal 80 that are supported by the foundation 9. There are several cylinders 81 that surround the load column in order to hold it on place while allowing only vertical movement (example up and down). There is a point to bolt 82 the load column in the lower portion to four levers (wedge shaped) with a pivot axis 84 proximal to the load column 76. The four levers have a dentate surface in the opposite end, which in turn rotates another gear 86 supported on the two sheets of metal. This said small gear 86 is in turn in the same axel 87 of a bigger wheel 88 than in terms continues to provide rotational energy to a gear of train supported by the same sheets of metal. In the picture we can notice how two axels further there is a chain 90 that provides the rotational energy to the main axis of the time consecutive escapement mechanism 15. The continuous rotation of this mechanism provides a consecutive power to the arm of the pendulums above the place of attachment of the pendulum 3 that in turn moves a crank lever 22 that makes the rotation of the drive shaft of the gravity generator 91. Please note that there are additional gears 92, 94 to further gear up the gravity force so that it would be easy to use a motor 94 to recycle the structure up.

FIG. 10A depicts a variation of the architectural mechanical prototype by using a vertical train of gears and by using an horizontal (arched) arm instead of a lever to power a dentate wheel that powers the gravity generator 23

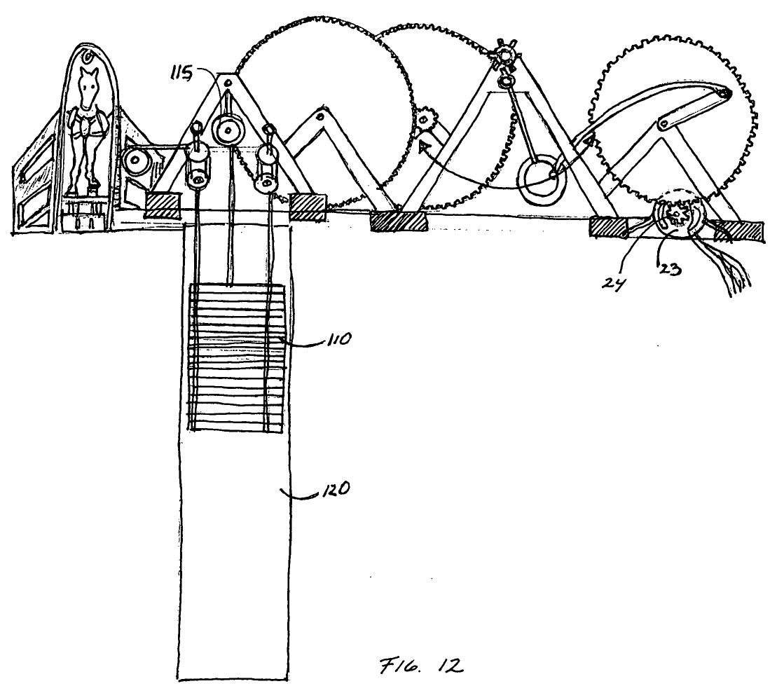

11. FIG. 11 A depicts a lateral view of the generator (simple mechanical prototype) using simple weights above the ground. The “weight energy” in this case represents several bars of steel or iron or any similar weight 110 that use a mechanism similar to the one of a big clock to power heavy pendulums continuously for approximately twenty-four hours to power the generator 23.

11 B depicts the same simple gravity generator in a superior view.

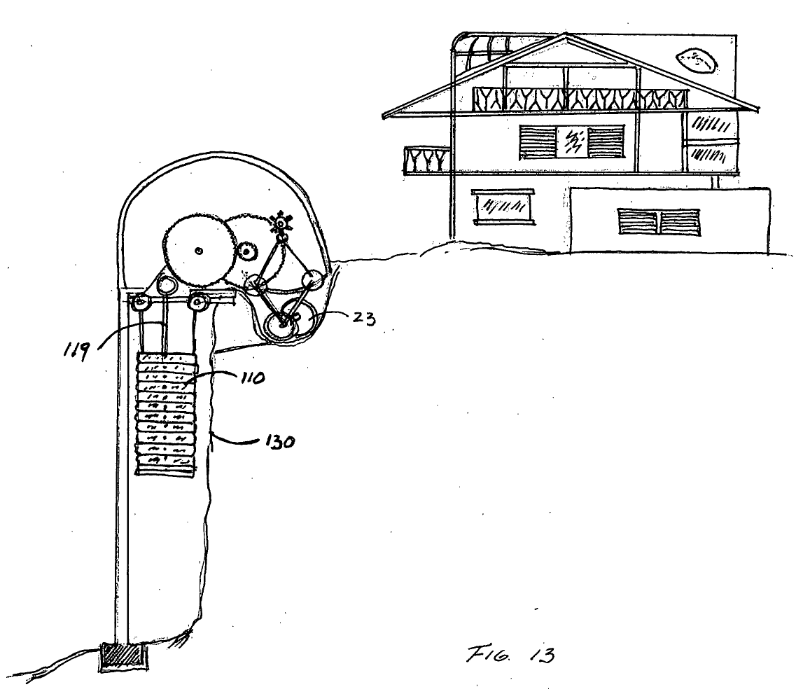

12. FIG. 12 depicts a simple mechanical prototype using a vertical tunnel 120 in order to save the cost of building this structure above the ground. The idea is to create a free space where the weight can be moved up and down periodically in order to power the mechanism that powers the gravity generator 23. Note that the weights are being fragmented so that they can be lifted one at the time whenever “rewinding” is necessary. There is a mechanical lifter 115 that facilitates this function. Please also notice the introduction of the concept of using animal force (example a horse) in order to provide the rotational movement to the mechanical lifter 115 once a day or as desired. The graphic represents the horse supported by a horse speeding vehicle (a mechanism that allows the animal to exert mechanical advantage of their weight and muscle contraction by using specially designed levers (that is a prior patent of the same author). The picture depicts also the concept of using a vertical tunnel or equivalent to allow the up and down movement of a weight to generate electricity (this saves part of the cost of the structure and keeps the weight out of voyeurs)

13 FIG. 13 depicts the use of the simple mechanical prototype generator 23 taking advantage of the topography. In this case the author wants to call the attention that we can generate very low cost electricity even on the top of a mountain by simple holding the appropriated amount of weight close to the cliff 130 by using a winch 119 of less than twenty meters in total length.

I claim:

1. The concept of using the force of gravity as a source of energy to generate electricity By means of using the weight and the velocity of one or more pendulums.

2. The concept of using hydraulics to power one or more turbine in order to power one or more pendulums to generate electricity.

3. The concept of using weight as a source of power to mechanical gears in order to power one or more pendulums to generate electricity.

4. A Gravity Generator of Electricity as in the preceding claims 1-3, further comprising a frame to hold the pendulums and the mechanism that powers them.

5. A Gravity Generator of Electricity as in the preceding claims 1-3, further comprising one or more turbine or power source to move the pendulums to generate electricity.

6. A Gravity Generator of Electricity as in the preceding claims 1-3, further comprising one or more levers in order to transform the energy of the pendulum into rotational force.

7. A Gravity Generator of Electricity as in the preceding claims 1-3, further comprising a time consecutive escapement or pin continuously spiral mechanism in order to power continuously multiple pendulums by using the same source of weight energy.

8. A Gravity Generator of Electricity as in the preceding claims 1-3, further comprising a specially designed attachment point or foundation in order to use weight energy from architectural structures by means of gears.

9. A Gravity Generator of Electricity as in the preceding claims 1-3, further comprising a specially designed attachment point or foundation in order to use weight energy from architectural structures by means of hydraulics.

10. A Gravity Generator of Electricity as in the preceding claims 1-3, further comprising more than one attachment point in architectural structures in order to alternatively receive the weight energy or “flips flop buildings”.

11. A Gravity Generator of Electricity as in the preceding claims 1-3, further comprising a weight source of stored energy periodically rewind by the use of animal force (like a horse).

12. A Gravity Generator of Electricity as in the preceding claims 1-3, further comprising a vertical tunnel or equivalent to allow the up and down movement of a weight to generate electricity

13. A Gravity Generator of Electricity as in the preceding claims 1-3, further comprising a low velocity turbine designed to be powered by high-pressure hydraulic fluid or equivalent liquid to generate electricity.
